(19) United States
(12) Patent Application Publication
(10) Pub. No.: US 2009/0309268 A1
(43) Pub. Date: Dec. 17, 2009

(54) METHOD FOR PRODUCING STRUCTURES OF COMPLEX SHAPES OF COMPOSITE MATERIALS

(75) Inventors: Frederick Cavaliere, Montigny Le Bretonneux (FR); Maurice Guitton, Lunenburg (CA); Severine Guitton, Lunengurg (CA)

Correspondence Address: Perman & Green, LLP, 99 Hawley Lane, Stratford, CT, 06614, US

(73) Assignee: EADS FRANCE, Paris (FR)

(21) Appl. No.: 12/296,689

(22) PCT Filed: Mar. 20, 2007
(86) PCT No.: PCT/EP2007/052621

§ 371 Date: Jun. 3, 2009

(30) Foreign Application Priority Data
Mar. 20, 2006 (FR) 06/50956

(51) Int. Cl. B29C 70/44

(52) U.S. Cl. 264/511

(57) ABSTRACT

A method for producing a composite material part having a so-called non-strippable shape includes producing mold components, or cores, which are to be extracted from the part after the composite material has been cured. In a first step a core is produced from an elastomeric bladder the granular solid material and the bladder is depressurized. In a second step, after setting the core and the composite material the volume of the core is modified in a controlled manner for example by selecting the solid granular material based on its thermal expansion properties or by acting on the pressure in the bladder.

### CROSS-REFERENCE TO RELATED APPLICATIONS

This application is the National Stage of International Application No. PCT/EP2007/052621, International Filing Date 20 Mar. 2007, which designated the United States of America and which International Application was published under PCT Article 21 (2) as WO Publication No. WO2007/107552 A1 and which claims priority to French Application No. 06/50956, filed 20 Mar. 2006, the disclosures of which are incorporated herein by reference in their entireties.

### BACKGROUND

1. Field

The disclosed embodiments relate to the field of producing parts of complex shapes made of composites that require molds during the manufacturing operations. More particularly, the process according to the aspects of the disclosed embodiments uses mold components that are trapped inside the part at the time it is produced and that are then extracted therefrom in order to make it possible to produce parts that are said to be non-demoldable.

2. Brief Description of Related Developments

Parts made from composites comprising fibers in a matrix, for example a resin, are usually produced using molds that are intended to give the material used the shape of said part.

The fibrous material, dry or preimpregnated with resin, is deposited on the mold whose shape it must adopt and undergoes a more or less complex cycle which may comprise phases of injecting resin and/or of pressurizing and/or of heating.

After the curing of the resin, generally by polymerization, the part in the process of being produced having achieved the desired mechanical and dimensional properties, is removed from the mold.

Parts having complex shapes sometimes make it necessary to use molds, certain components of which may be stuck in the part at the time it is demolded. Thus, it is frequently hollow or enveloping shapes that make it necessary for the mold to comprise particular components or cores which fill the hollow shapes of the part while it is being produced.

In order for it to be possible to extract said cores without damaging the part that has just been produced, it is then necessary, except when producing the part in several components that are assembled in a subsequent step, to construct particular cores made of several parts that are uncoupled using keys in order to be removed from the part. However, such cores made of several components fitted together cannot always be produced in practice and are always more expensive than molds made from a single component and may prove very complex both at the design level and at the implementation level.

Another method also used consists in producing the core in a material that makes it possible to destroy said core in order to remove it from the part, for example by a mechanical action or by melting or dissolving the material of the core. In this case, the difficulty is in finding a material to produce the core which is economically acceptable, is capable of withstanding the sometimes extreme conditions encountered during the process for producing the part made from a composite, is sufficiently solid to withstand the handling and mechanical stresses during the preparation of the part while satisfying the strict shape tolerances and can be removed mechanically or by melting without risk of damaging the part or be dissolved by water or by another solvent compatible with the material of the part. These combinations of conditions are not always possible and in any case it is necessary to manufacture as many cores or sets of cores as parts to be produced which is, along with the phase of removing the core and of meeting current hygiene and safety conditions, expensive from an industrial point of view.

Another method consists in producing a core in a material which can be sufficiently deformed so that said core can be extracted by deformation. Thus a core made from an elastomer, optionally comprising recesses, could be removed by stretching and necking through an opening having smaller dimensions than those of the cross section of the core. The failing of cores that use a deformable material is their dimensional instability due to their low rigidity which does not make it possible to obtain reproduction, within the tolerances required by certain applications, of the results during the manufacture of the parts. Furthermore, the low necking coefficient does not make it possible to solve situations with significant variations in the cross section of the core, in particular when the core must be removed through an opening of reduced cross section.

### SUMMARY

In order to produce a core that is both rigid and that can be removed from the part after curing, one solution consists in producing a bladder in a material made from an elastomer, which bladder is filled with a granular material. In a first step the bladder, the shape of which is preferably produced following the desired shape of the core, is placed in a mold, against the walls of which it is applied by means of a vacuum between the walls of the bladder and those of the mold corresponding to the desired shape of the core. After filling the bladder with the granular material, the vacuum between the walls of the mold and of the bladder is broken and the inside of the bladder is put under vacuum which has the effect of compacting and lumping together, under the crushing forces of the bladder subjected to atmospheric pressure, the granular material contained by said bladder, thus giving the latter both the desired shape and rigidity to act as a support for the positioning of fabrics preimpregnated with resin. After curing the resin, the vacuum inside the bladder is broken and the bladder is opened in order to remove the granular material. The emptied shell of the bladder can then be deformed sufficiently to be removed from the composite part in which it is trapped. U.S. Pat. No. 5,262,121 describes such a process for producing complex composite piping. One problem that is faced with this type of production is the dimensional quality of the part produced which may be insufficient. This is because this quality is affected by variations in the actual dimensions of the bladder and/or of the core after being put under vacuum and also by those due to the heating and pressure cycles generally used for the polymerization of the resin. Although these variations in dimensions are not troublesome for widely available composite parts such as, for example, air conditioning piping, they are generally unacceptable for producing high-performance composite parts, such as, for example, structural parts with tight geometrical tolerances intended for a precise assembling and of which the dimensional characteristics are often critical as is the structural soundness of the material of the finished part which must not contain gas bubbles or porosities, nor pockets of resin, nor “dry” fibers, phenomena that lead to high levels of scrap during manufacture and are equally sources of delamination when the part is subjected to operating stresses which leads to oversizing the parts, the structural strength of which must be/is essential.

In order to produce parts made from a composite, comprising shapes that cannot be demolded through conventional mold shapes, with the dimensional and structural qualities required for parts of structural qualities such as the parts used in the aeronautical field, the process according to the aspects of the disclosed embodiments uses an extractable core comprising a flexible bladder, the rigidity of which is provided by filling with a granular solid material and with an intergranular fluid.

The process for producing a part made from a composite comprising fibers with a resin that changes from a pasty or liquid state to a solid state in the course of a curing phase and comprising a partially sealed zone, in a volume corresponding completely or partly to the partially sealed zone is occupied by a core, said core comprising a bladder made of a flexible material that has an outer surface that delimits a volume of the core, the shapes and the dimensions of which are in keeping with the volume of the partially sealed zone and having an inner surface that determines a volume of the bladder, which volume of the bladder is filled with a granular solid material and an intergranular fluid, is in which a pressure is exerted on the inner surface of the bladder by the granular solid material and/or the fluid so that the volume of the core is modified in a controlled manner before the composite is completely cured. This modification of the volume of the core before the resin is cured has the effect of balancing and homogenizing the pressures over the various parts used that makes it possible to obtain a shape of the part within the desired tolerances and therefore to prevent local deformations of the part, and also a good material soundness.

In particular when the curing of the resin is combined with a thermal curing phase with an increase in the temperature, the volume of the core is modified in a controlled manner by choosing the granular solid material as a function of its thermal expansion coefficient and of the increase in temperature associated with the curing phase of the resin.

To avoid deformations of the part during its production despite the increase in the temperature in the course of the curing phase of the resin, the volume of the core is modified in a controlled manner by choosing the granular solid material from materials that have a thermal expansion coefficient close to the thermal expansion of the composite of the part.

In particular, the granular solid material may be a borosilicate glass or an Invar type iron/nickel alloy having a low expansion coefficient.

Generally, when a low expansion coefficient is desired the granular solid material is chosen from materials for which the thermal expansion coefficient is between 2×10⁻⁶ K⁻¹ and 9×10⁻⁶ K⁻¹.

When the core must advantageously exert a pressure on the part in the process of being produced, the volume of the core is modified in a controlled manner by choosing the granular solid material from materials that have a thermal expansion coefficient greater than the thermal expansion coefficient of the composite of the part, for example an aluminum alloy.

When the resin is cured by a thermal cure, advantageously the core is filled with a granular solid material and/or an interstitial fluid chosen with a thermal conductivity coefficient capable of ensuring the diffusion of the heat during the thermal cure.

Alone or in combination with the action of the granular solid material, the action of the core before the curing of the resin is also obtained by increasing the pressure Pn of the interstitial fluid before curing the resin.

In particular, the pressure Pn is increased to a value substantially equal to a pressure Pa used to keep the fibers in the core during the curing phase of the resin, having the effect of balancing the pressure exerted on the part by a pressurized bladder.

In particular, the pressure Pn is increased to a value at least equal to a pressure Pr for injecting the resin, for example when the process uses a transfer of resin to dry fibers, in order to control the pressure of the resin Pr, to make it homogeneous, to allow better control of the dimensions, to obtain a good material soundness, and to prevent the surface of the core and therefore the wall of the part from being deformed by the pressure of the resin.

Advantageously, so that the bladder is detached from the wall of the part and can be removed from the part in which it is trapped, the pressure Pn in the bladder of the core, previously emptied of the granular solid material, is reduced to a value below atmospheric pressure which causes its partial crushing.

### BRIEF DESCRIPTION OF THE DRAWINGS

The detailed presentation of an exemplary embodiment of the process according to the aspects of the disclosed embodiments is made with reference to the drawings that represent:

FIG. 1: an example of a part produced from a composite and comprising a non-demoldable hollow volume.

FIG. 2: a core corresponding to the hollow volume of the part presented in FIG. 1 is composed of a flexible bladder.

FIG. 3: a mold made of several components intended for preparing the core using the flexible bladder.

FIG. 4: the mold and the bladder in position for preparing the core during the step of filling the core and before the step of reducing the pressure in the bladder.

FIGS. 5a, 5b and 5c: example of using the bladder according to various processes for producing composite parts: part obtained by depositing preimpregnated fibers on the former of the core (FIG. 5a), part produced in a mold comprising a hollow cavity in which preimpregnated fibers are deposited and in which the core is applied (FIG. 5b), part produced in a sealed mold containing the core according to the resin transfer technique (FIG. 5c).

FIG. 6: principle for extracting the bladder from the core of the part after curing of the composite.

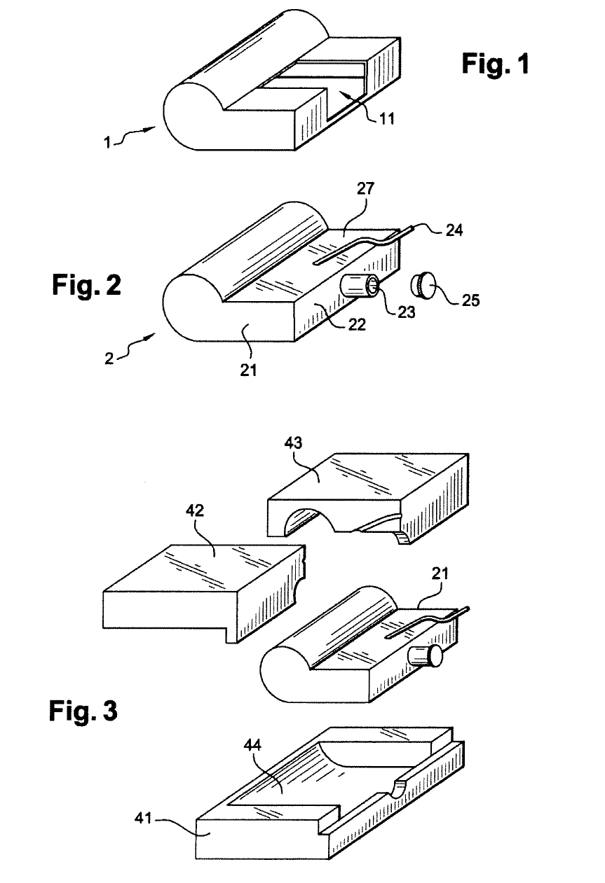

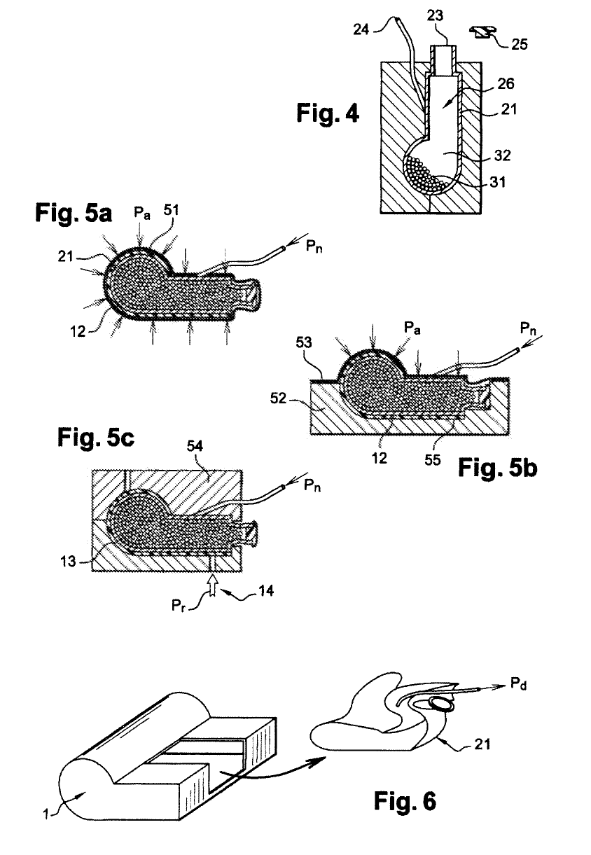

### DETAILED DESCRIPTION OF THE DISCLOSED EMBODIMENTS

The composites for which the disclosed embodiments are preferably intended are materials comprising fibers such as, for example, glass fibers, carbon fibers or Kevlar® type aramid fibers, trapped in an organic matrix such as, for example, a polyester resin or an epoxy resin.

These types of composites are today widely used in many industrial sectors for producing parts having more or less complex shapes and which may be filled to a greater or lesser extent.

One widespread technique for producing a composite part consists in depositing the fibers on a former or a mold having the desired shape for the part to be produced. The fibers are deposited after having been coated with an unpolymerized resin, these are then referred to as preimpregnated fibers, or else are deposited dry then subsequently coated by resin transfer according to the technique known as RTM.

In other step, the resin initially in the pasty or liquid state is cured, in general by polymerization, for example during a thermal curing phase.

During the curing step and/or during the step which precedes it, it is essential to apply perfectly controlled pressures and temperatures so that the composite acquires its structural properties. In particular, it is advisable to avoid the formation of air bubbles in the composite and also accumulations of resin without fibers or with too low a concentration of fibers.

One of the main difficulties during the application of the pressures necessary with the view of obtaining this result is in not generating local deformations of the part and in maintaining a surface finish of the parts produced as close as possible to the final desired finish.

When a part 1 comprises a zone 11 that is partially or almost completely sealed on itself, a core 2 makes it possible to retain the space that must not be filled with resin and that serves as a support for the fibers 12, 13 deposited to form the part. The core 2 must also withstand the pressure in order not to be crushed or deformed by these pressures that are exerted during the placement of the fibers on the core, in particular when automatic fiber-laying devices are used, or on the part in the process of being produced during the curing phase by means for compressing the fibers, or that is exerted by the resin when the latter is injected.

This core is produced by means of a bladder 21 which is filled with a granular solid material 31, that is to say a material divided into components of small enough dimensions so that the components can fill the internal volume 26 of the bladder 21 even into the smallest spaces inside the bladder. The bladder is produced with external dimensions corresponding to the dimensions desired for the core, in a flexible material such as an elastomer capable of withstanding the chemical and thermal environment encountered during the application of the process for producing the part. Silicone resins are found that have characteristics which make it possible to satisfy these conditions in most common cases, but other materials, for example rubbers, may also be envisioned. On at least one of its faces 22 that remains accessible when the part 1 is produced, the bladder 21 comprises a first opening 23 through which the components of the granular solid material 31 may be introduced and removed. On at least one of its faces 27 that remains accessible during the production of the part 1 and when the part is produced, the bladder 21 comprises a second opening 24 that makes it possible to decrease or increase the pressure of a fluid 32 contained in the bladder. Said first opening 23 and said second opening 24 may be on different faces of the bladder on the condition that they remain accessible in particular when the pressure inside the core has to be modified via the second opening 24 and when the core must be removed from the part via the first opening 23. In particular, one and the same opening may provide the role of both openings or else a stopper 25 mounted on the first opening, after the core has been filled with the granular solid material, may comprise the second opening. Preferably, the components of the granular solid material 31 have suitable dimensions and shapes so that said components can easily flow through the first opening 23 of the bladder 21. These are, for example, beads made from a metallic or glassy material or any other material having sufficient rigidity and withstanding the temperature conditions encountered during the production of the part.

In order to give the bladder 21 the desired shape and dimensions and so that these are stable during the operations for preparing the part to be produced, the following steps are carried out:
1—the bladder 21 is placed in a support, for example a hollow former 44 made from parts 41, 42, 43 that can be separated in order to allow the bladder 21 to be positioned and removed, giving it the shapes and dimensions desired for the core 2; then
2—the internal volume of the bladder 21 is completely filled with components of granular solid material 31 via the first opening 23 made for this purpose;
3—the volume remaining in the bladder which corresponds to the interstices between the components of granular solid material is filled with a fluid 32;
4—the filling opening 23 is sealed by a stopper 25 and a vacuum is created inside the bladder by sucking some of the fluid 32 inside the bladder 21 through means (not shown) made in the second opening 24; and
5—the core is removed from the support while maintaining the vacuum which allows the core to keep its dimensions and its shape due to the compacting of the granular solid material 31 inside the bladder 21.

It should be noted that the bladder of the core may be partially filled with granular solid material and/or fluid during its positioning in the course of step 1. A partial filling does not upset this step 1 and it makes it possible to reduce the complete filling time of step 2.

Furthermore, the fluid 32 used to fill the interstitial volume during step 3 is advantageously a gas and more advantageously air.

However, if high pressures are desired during subsequent steps when the pressure in the core 2 must be increased, the fluid is advantageously a liquid due to its incompressibility relative to a gas.

The core 2 thus produced is used during operations for depositing fibers 12, 13 in the same way as a demoldable core or a core intended to be destroyed after curing the composite would be used. In particular, the core 2 may act as a support for the fibers 12, 13 that must constitute a part 1, the core of which substantially represents the shape, or be inserted between various layers of fibers in order to retain a hollow space in a complex part.

In a first embodiment of the process according to the aspects of the disclosed embodiments, when the various parts of the mold and the fibers 12, 13 have been positioned and where appropriate the resin 14 injected, the pressure Pn in the core 2 is increased so that the pressure Pa exerted by the other means of the mold when these means are means that have a certain flexibility, for example a bladder 51, 53 as illustrated in FIGS. 5a and 5b or an elastomeric counterform (not shown), in particular those located on the face of the part opposite the face in contact with the core, or balanced.

In a second embodiment of the process according to the aspects of the disclosed embodiments, when the various parts of the mold 52, 54 and the fibers 12, 13 have been positioned and where appropriate the resin 14 injected, the pressure Pn in the core 2 is increased so that the core compresses the composite 12, 13 against the walls of the mold 52, 54 when this is a mold having rigid walls. In particular, when the part is produced according to a resin transfer process as illustrated in FIG. 5c, after injecting the resin 14 until the fibers 13 are completely impregnated and feeding at a vacuum level Pr, the openings for injecting the resin 14 are closed and the pressure Pn is increased in the bladder of the core to a value greater than or equal to the pressure value Pr in order to compact the composite and homogenize the pressure.

By this process, on the one hand a better pressurization of the fiber 12, 13 comprising the resin is ensured which has the effect of greatly reducing the risk of the presence of air bubbles and of improving the volume content of fibers within the composite and, on the other hand, the local deformations induced by surface irregularities and the inevitable defects in the sizes of a core 2 produced with an elastomeric bladder 21 are avoided. Moreover, when a rigid mold former 52, 54 is used, the process guarantees that the wall of the part 1 in the process of being made perfectly matches the surface of the mold, including in its internal structure, that is to say that the fibers 12, 13 are oriented in directions substantially parallel to the surface of the mold 52, 54.

Thus, according to the type of parts produced and the process for producing composites used:
a) The core as illustrated in FIG. 5a is used as a support for depositing preimpregnated fibers 12 then a pressure is exerted on the outside of the part which is in the process of being made in a direction of the core 2, for example using a bladder 51 which surrounds the part comprising the core 2 subjected to a pressure Pa and in which a partial vacuum is created. When this external pressure Pa is established, the pressure Pn in the core is increased so that the composite 12 is compressed homogeneously and substantially isostatically during its polymerization phase between the pressure exerted by the outer bladder 51 and by that 21 of the core. Advantageously the pressure Pn in the core 2 is established at the value of the pressure Pa that is exerted on the outer bladder 51, in general the pressure of the autoclave in which the part 1 is produced.
b) As illustrated in FIG. 5b, the core 2 is used as a counterform to apply preimpregnated fibers 12 already deposited in a cavity 55 of a mold 52 against which the fibers 12 must be held then, where appropriate, the core 2 is covered with new preimpregnated fibers 12. A pressure is exerted from the outside of the part in the process of being made in order to compress the composite 12 against the mold 52, for example either by means of an outer bladder 53 which covers the part comprising the core 2 and by means of the creation of a partial vacuum between the outer bladder and the mold, or by means of a counterform (solution not shown) which may comprise a support part made of an elastomer. When this outer pressure Pa is established, the pressure Pn in the core is increased so that the composite 12 is compressed during its polymerization phase between the pressure exerted by the outer bladder or the counterform and by that exerted by the bladder of the core. Advantageously when an outer bladder 53 is used, the pressure Pn in the core 2 is established at the value of the pressure Pa that is exerted on the outer bladder, in general the pressure of the autoclave in which the part is produced.
c) As illustrated in FIG. 5c, the core 2 is placed between the dry fibers 13 deposited in a sealed mold 54, the inner surfaces of which correspond to the outer surfaces of the part 1 to be produced. A fluid resin 14 is injected inside the mold 54 which fills the space between the fibers 13 according to the process for producing composite parts known under the name of resin transfer molding (RTM). Before the resin 14 cures, the pressure Pn is increased in the core 2 in order to compress the zones of the part between the core 2 and the walls of the mold 54. In this case, the pressure Pn in the core 2 is chosen to be at least equal to the pressure Pr at which the resin 14 is injected or greater than the pressure variation value as a function of the desired compression of the fibers 13 in the zone of the core 2.

In any case, when the curing cycle of the material of the part 1 is finished, the pressure Pn in the bladder 21 of the core and where appropriate the other pressures used in the process for producing the composite part are brought to atmospheric pressure and the part is removed from the mold.

The core 2 is then emptied of the components of granular solid material 31 that it contains through the first opening that has remained accessible, which makes it possible to acquire the flexibility and the possibility of being deformed in order to be removed by pulling from the volume of the part that it has helped to form as illustrated in FIG. 6.

Advantageously, the first opening 23 of the bladder 21 of the core emptied of components of granular solid material 31 is resealed and a vacuum Pd is created in the bladder, for example by using the second opening 24, so that the bladder is deformed, flattened or crushed, under the effect of atmospheric pressure which makes it possible, on the one hand, to detach the bladder 21 from the composite material of the part 1 without significant effort and, on the other hand, to facilitate the extraction of the bladder 21 through the opening in the part.

The part may comprise one, two or several cores, each being prepared, put in place and extracted by application of the same process in order to participate in the production of the composite part.

Advantageously, when the process for producing the composite part uses a thermal cure to cure the resin used, which is frequently the case, the granular solid material 31 and where appropriate the fluid used to fill the bladder 21 of the core 2 are chosen as a function of their thermal conductivity and thermal expansion characteristics in order to participate in the thermal behavior of the mold.

Advantageously, when the dimensional stability of the mold is essential for producing the part, the granular solid material 31 is chosen with a thermal expansion coefficient substantially equal to that of the composite in question. In practice, among the composites having low expansion coefficients, a borosilicate glass is advantageously chosen as the granular solid material. Borosilicate glasses, that are rich in silica, are known for their excellent high-temperature behavior and their low thermal expansion coefficient around 3.5×10⁻⁶ K⁻¹, substantially equal to that of common composites.

A contrario, the choice of a material that has a substantial increase in volume with temperature makes it possible to increase the dimensions of the core 2 in a controlled manner when the temperature increases during the thermal cure with the effect of participating in the pressure generated by the core 2 on the composite during polymerization. Such an effect is, for example, obtained with an aluminum alloy having an expansion coefficient of around 24×10⁻⁶ K⁻¹ especially if the part is produced in a hollow mold made with a material having a lower thermal expansion coefficient. Since the expansion obtained along one direction has an absolute value that is a function of the dimension of the core 2 in the direction in question, the use of a core having controlled expansion will usually be used when the core has dimensions substantially equivalent in all directions in order to obtain a homogeneous expansion of the core.

When a precise value of the expansion coefficient is sought without one material simply giving this value, it is advantageous to mix components of granular solid material with different expansion coefficients to obtain the desired value.

Advantageously, when a rapid and homogeneous diffusion of the heat is desired, the granular solid material is chosen with a high thermal conductivity, for example a metal alloy. This alloy will be, for example, based on aluminum if the expansion is without drawbacks or if it is desired, and will be, for example, an alloy having a low expansion coefficient such as an Invar (metal alloy based on iron and having a high nickel content) if a low thermal expansion coefficient is desired in combination with a high thermal conductivity.

In any case, components of granular solid material 31 having spherical or sufficiently blunted shapes are preferably chosen so that the components flow easily into the core 2 when it is filled or emptied and so that the drainage of the fluid and the resulting pressure are homogeneous when the pressure Pn is decreased or increased in the bladder 21 of the core 2. Moreover, the use of substantially spherical components makes it possible to obtain a compact filling leaving a volume unoccupied by said components of around 40% which makes it possible to lighten the core 2 produced in a not insignificant manner when the fluid is a gas. For example, when a dense material is used for said components such as Invar, the density of which is around 8, the bulk density of the core obtained is less than 5.

What is claimed is:

1. A process for producing a part made from a composite, said composite comprising fibers coated with a resin that changes from a pasty or liquid state to a solid state in the course of a curing phase, during which curing phase the resin is subjected to a temperature increase, said part comprising a partially sealed zone, in which a volume corresponding completely or partly to the partially sealed zone is occupied, at least at certain steps of the process, by a core, said core comprising a bladder made of a flexible material that has an outer surface that delimits a volume of the core, the shapes and the dimensions of which are in keeping with the volume of the partially sealed zone and having an inner surface that determines a volume of the bladders, which volume of the bladder is filled with components of a granular solid material and an intergranular fluid, characterized in that the components of the granular solid material are chosen in order to obtain a bulk expansion coefficient of the granular solid material such that the volume of the core is modified in a controlled manner, that is to say that the dimensions of the core vary in a predetermined manner, under the effect of the temperature increase associated with the curing phase of the resin.

2. The process as claimed in claim 1, in which the volume of the core is modified in a controlled manner by choosing the components of the granular solid material from components of which the materials have a thermal expansion coefficient substantially equal to the thermal expansion coefficient of the composite of the part.

3. The process as claimed in claim 2, in which the components of the granular solid material chosen are predominantly composed of a borosilicate glass.

4. The process as claimed in claim 2, in which the components of the granular solid material chosen are predominantly composed of an Invar type iron/nickel alloy having a low expansion coefficient.

5. The process as claimed in claim 2, in which the granular solid material is composed of components chosen from components made from one material or from several materials, the granular solid material then comprising a mixture of components produced with different materials, the thermal expansion coefficients of which are between 2×10⁻⁶ K⁻¹ and 9×10⁻⁶ K⁻¹.

6. The process as claimed in claim 1, in which the volume of the core is modified in a controlled manner by choosing the components of the granular solid material from components of which the materials have a thermal expansion coefficient greater than the thermal expansion coefficient of the composite of the part.

7. The process as claimed in claim 6, in which the components of the granular solid material chosen are predominantly composed of an aluminum alloy.

8. The process as claimed in claim 1, in which the intergranular fluid is an incompressible fluid.

9. The process as claimed claim 1, in which the granular solid material and/or the intergranular fluid are also chosen with a thermal conductivity coefficient capable of ensuring the diffusion of the heat and the homogeneity of the temperature when the temperature of the part is modified during the implementation of the process.

10. The process as claimed in claim 1, in which the pressure Pn of the interstitial fluid is increased during the curing phase of the resin.

11. The process as claimed in claim 10, in which the pressure Pn is increased to a value substantially equal to a pressure Pa used to keep the fibers in the core during the curing phase of the resin.

12. The process as claimed in claim 11, in which the pressure Pn is increased to a value at least equal to a pressure Pr for injecting the resin.

13. The process as claimed in claim 1, in which the pressure Pn in the bladder of the core is reduced to a value Pd below atmospheric pressure after having been emptied, at least partially, of the granular rigid material in order to extract the bladder from the part.
